(19) United States
(12) Patent Application Publication
(10) Pub. No.: US 2003/0192009 A1
(43) Pub. Date: Oct. 9, 2003

(54) Method and system for representing text using markup language

(75) Inventors: Jean-Francois Arcand, Santa Clara, CA (US); Ramesh Babu Mandava, San Jose, CA (US)

Correspondence Address: MARTINE & PENILLA, LLP, 710 LAKEWAY DRIVE, SUITE 170, SUNNYVALE, CA, 94085, US

(73) Assignee: Sun Microsystems, Inc., Palo Alto, CA

(21) Appl. No.: 10/116,832

(22) Filed: Apr. 4, 2002

(51) Int. Cl. G06F 17/24

(52) U.S. Cl. 715/513

(57) ABSTRACT

A method for tracking assertions in an application is provided. The method includes providing a specification for the application, identifying each assertion in each chapter of the specification, and generating a markup language document. The specification is divided into chapters, which define functional aspects of the application. The markup language document has an associated tagged entry for each of the identified assertions. Each tagged entry has an identifier tag which correlates the tagged entry to a specific chapter of the specification.

### BACKGROUND OF THE INVENTION

1. Field of the Invention

The present invention relates generally to software processing, and more particularly, to methods and systems for improving computer software testing process by enhancing the representation of computer software specifications.

2. Description of the Related Art

As the use of software in performing daily tasks is increasing rapidly, assessing software reliability through software testing has become an imperative stage in software development cycle. As is well known, software testing is used to find and eliminate defects (i.e., bugs) in software, which if undetected, can cause the software to operate improperly.

Generally, computer software testing starts by the implementation group creating an implementation document using the computer software specification. The software testers then review the implementation document to verify the compatibility of the implementation document with the specification document.

Usually, for ease of reference, specification documents are divided into, among others, chapters, sections, subsections, and assertions. Furthermore, typically, a test suite is implemented to test each specification. In creating the test suite to test a particular specification, the test group architect manually reviews the specification document so as to find all the assertions. As used herein, assertions are defined as boolean expressions designed to convey a necessary behavior of the software program and are typically included in the text. Among others, assertions are identified by implementation specific terminology such as “must,” “should,” “always,” “optional,” etc.

Upon finding all the assertions, each assertion is mapped to an application framework, which are then initiated so as to execute each of the corresponding assertions. A test suite is then developed using all of the application frameworks. After the development of each test suite has concluded, each test application framework mapped to the corresponding assertion in the specification. As this tedious and time consuming task is done manually by the test developers, the mapping task is considered to be one of many drawbacks of the prior art testing process.

The above-mentioned shortcoming becomes even more pronounced if the specification document is modified subsequent to the locating and marking of the assertions. For instance, any revision to the specification requires the test developers to review the revised specification so as to locate all assertions, again, in an attempt to determine whether there have been any modifications to any of the chapters, sections, subsections, or assertions. That is, the test developer must match each of the initial assertions in the original specification against the assertions in the revised specification so as to determine whether any of the initial assertions has been modified or deleted, and whether any new assertions have been added. Simply stated, each of the assertions in the revised specification should be mapped to the corresponding assertion in the initial specification, if any. As matching the assertions is very time consuming, it slows down the test process and significantly reduces the productivity of test developers, thus marking the second shortcoming of the prior art testing process. Additionally, the initial test suite should be modified to include the revised application frameworks to accommodate each of the assertion modifications, additions, or deletions.

Yet another shortcoming of the prior art software testing process is its inability to display just the assertions as they correspond to a chapter, section, and subsection. Additionally, the software testing process of the prior art lacks the flexibility to display varied information as requested by the test developers and users. As a consequence, retrieving or displaying of data becomes very time consuming and complicated, requiring the test developers to develop individual tools to achieve each of these tasks.

In view of the foregoing, there is a need for a flexible methodology and system for enhancing software testing process by improving the representation of software specifications.

### SUMMARY OF THE INVENTION

Broadly speaking, the present invention fills these needs by providing a flexible method and system for improving the software testing process through simplifying a software specification representation by creating a second document using a markup language tags. In one example, the second document is an assertion document configured to be an Extensible Markup Language (XML) representation of the specification document. In one embodiment, the assertion document includes almost all the chapters, sections, subsections, and assertions of the specification documents as tagged using XML. It should be appreciated that the present invention can be implemented in numerous ways, including as a process, an apparatus, a system, a device, or a method. Several inventive embodiments of the present invention are described below.

In one embodiment, a method for tracking assertions in an application is disclosed. The method includes providing a specification for the application, identifying each assertion in each chapter of the specification, and generating a markup language document. The specification is divided into chapters, which define functional aspects of the application. The markup language document has an associated tagged entry for each of the identified assertions. Each tagged entry has an identifier tag which correlates the tagged entry to a specific chapter of the specification.

In another embodiment, a method for tracking assertions in an application is disclosed. The method includes providing a specification for the application, identifying each assertion in each chapter of the specification, generating markup language document, and displaying the markup language document. The specification is divided into chapters, which define functional aspects of the application. The markup language document has associated tagged entry for each of the identified assertions. Each tagged entry has an identifier tag, which correlates the tagged entry to a specific chapter of the specification. The associated tagged entry for each of the identified assertions facilitates retrieval of a requested assertion.

In yet another embodiment, a computer program embodied on a computer readable medium for facilitating a retrieval of an assertion in an application is disclosed. The computer program includes a code segment that receives a request to locate a particular assertion. The computer program also includes a code segment that runs during an execution of the computer program. The code segment is configured to inspect a markup language document to find the particular assertion. The computer program also includes a code segment that provides a response to the request to locate the particular assertion.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1A is a simplified illustration of an exemplary software specification, in accordance with one embodiment of the present invention.

FIG. 1B-1 is a simplified diagram illustrating the creating of an assertion document by tagging the plurality of assertions in the text of a software specification, in accordance with another embodiment of the present invention.

FIG. 1B-2 depicts the XML representation of a plurality of assertions in a chapter of the specification document, in accordance with yet another embodiment of the present invention.

FIG. 1B-3 depicts the XML representation of a plurality of assertions in a chapter of the specification document, in accordance to yet another embodiment of the present invention.

FIG. 1B-4 depicts the XML representation of a plurality of assertions in a chapter of the specification document, in accordance to still another embodiment of the present invention.

FIG. 1B-5 depicts the XML representation of a plurality of assertions in a chapter of the specification document, in accordance with still another embodiment of the present invention.

FIG. 2A-1 is a simplified illustration of a first revised specification and the creating of an assertion document by tagging the plurality of assertions in the text of the first revised specification, in accordance to yet another embodiment of the present invention.

FIG. 2A-2 depicts the XML representation of a plurality of assertions in a chapter of the first revised specification, in accordance to yet another embodiment of the present invention.

FIG. 2A-3 depicts the XML representation of a plurality of assertions in a chapter of the first revised specification, in accordance to yet another embodiment of the present invention.

FIG. 2A-4 depicts the XML representation of a plurality of assertions in a chapter of the first revised specification, in accordance to yet another embodiment of the present invention.

FIG. 2A-5 depicts the XML representation of a plurality of assertions in a chapter of the first revised specification, in accordance to yet another embodiment of the present invention.

FIG. 3 is a flow chart diagram of method operations performed to create an XML assertion document, in accordance with yet another embodiment of the present invention.

FIG. 4 is a flow chart diagram of method operations performed to create an assertion document using a software specification document, in accordance with yet another embodiment of the present invention.

### DETAILED DESCRIPTION OF THE PREFERRED EMBODIMENTS

Inventions for simplifying software specification testing by enhancing representation of software specifications through implementing a second document tagged using a markup language and methods for implementing the same, are disclosed. In one example, the second document is an assertion document wherein each chapter, section, subsection, and assertion is tagged using the Extensible Markup Language (“XML”), allowing the test developers to easily locate, retrieve, and display specific information, as needed. In one example, Extensible Stylesheet Language (XSLT) Stylesheet is implemented to transform the assertion document into a Hyper Text Markup Language (HTML) document. It will be understood, however, to one skilled in the art, that the present invention may be practiced without some or all of these specific details. In other instances, well known process operations have not been described in detail in order not to unnecessarily obscure the present invention.

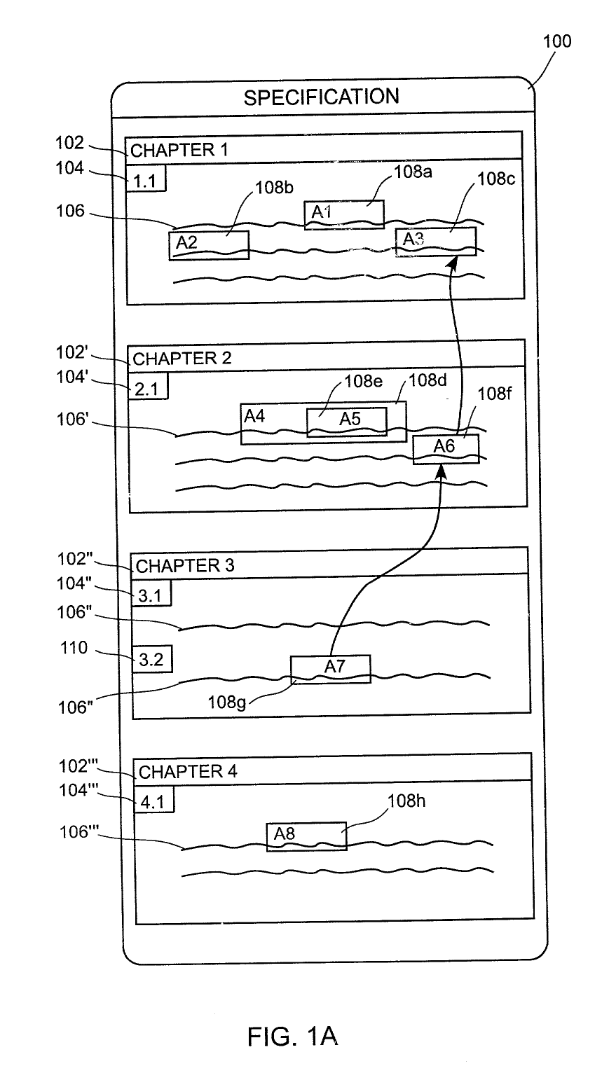

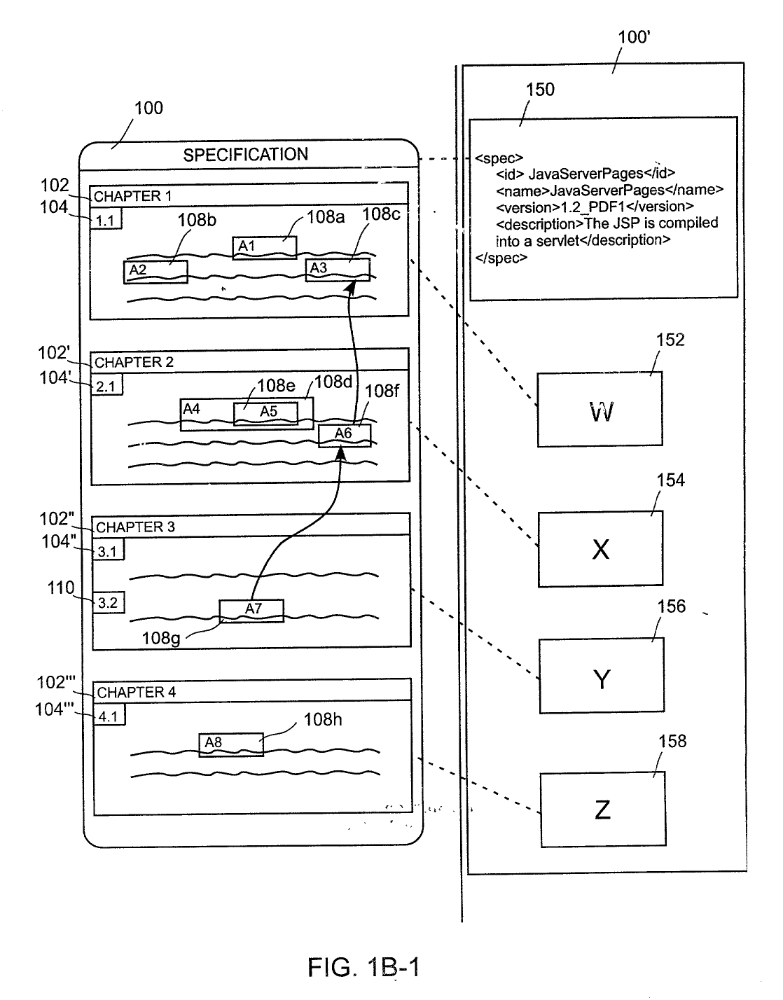

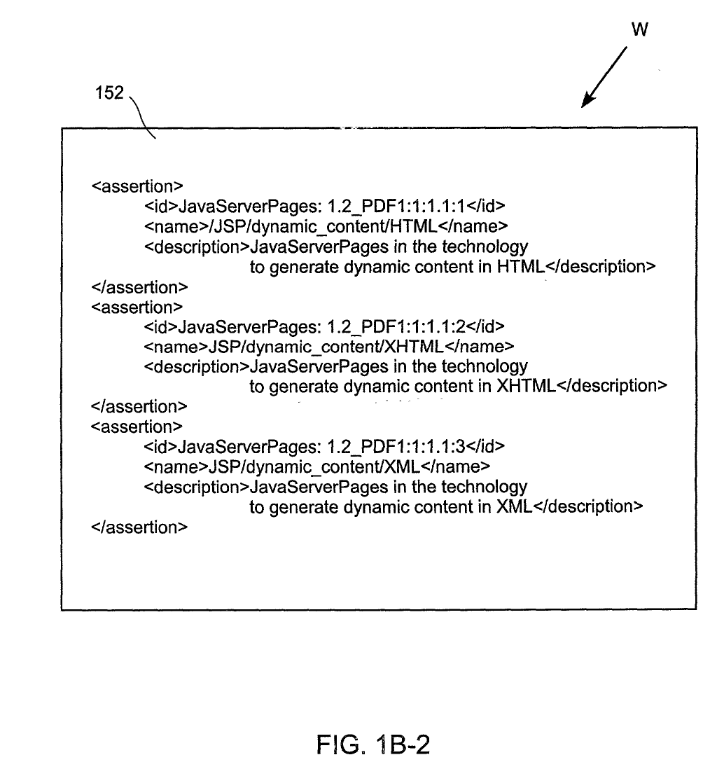

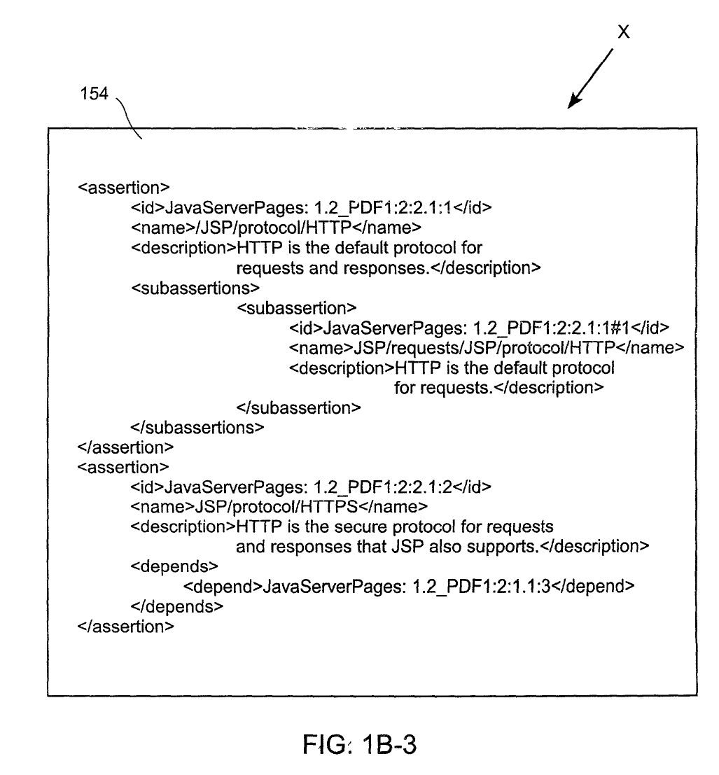

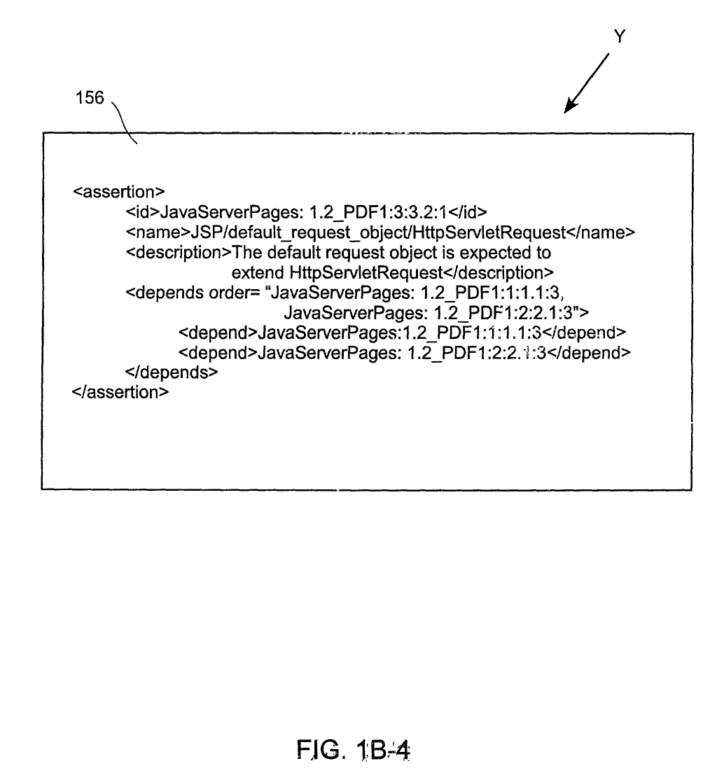

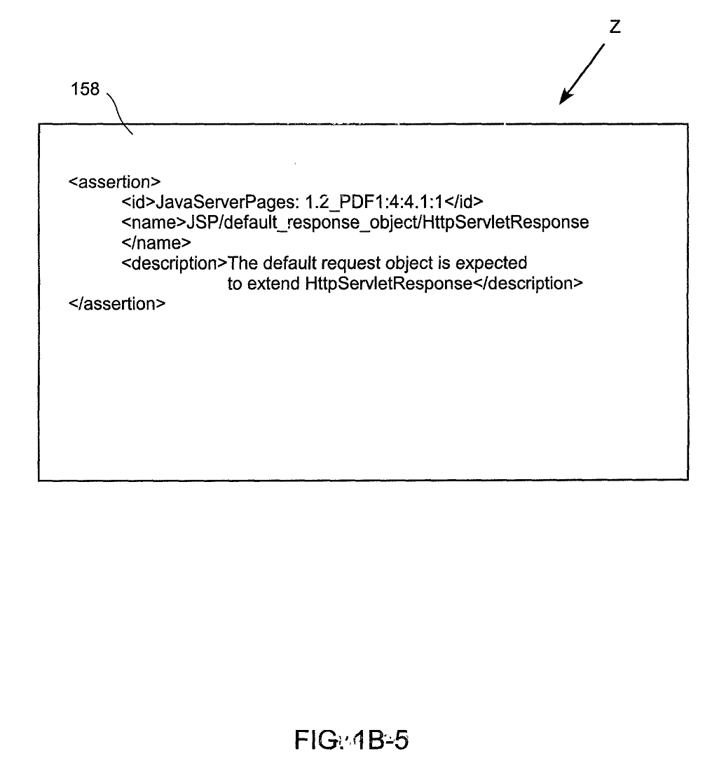

FIG. 1A is a simplified illustration of an exemplary software specification 100, in accordance with one embodiment of the present invention. The software specification 100 includes a plurality of chapters, chapter 1 102 through chapter 4 102′″. As shown, each of the chapters, chapter 1 102, chapter 2 102′, chapter 3 102″, and chapter 4 102′″ respectively include sections 104-104′, 110, and 104″-104′″.

Each of the chapters 102 through 102′″ contains text 106 through 106′″, which as shown, each includes a plurality of assertions. In one example, the assertions can easily be identified while in a different example, the assertions are identified upon a closer inspection of the text by an assertion writer. As used herein, the assertion writer is the person who transforms the specification document into an assertion document.

In the embodiment of FIG. 1A, the text 106 includes a plurality of assertions, first assertion 108a, second assertion 108b, and third assertion 108c. The text 106′ contained within section 1.1 104′ of the chapter 102′ includes a fourth assertion 108d, a fifth assertion 108e, and a sixth assertion 108f. As shown, the fourth assertion 108d has a sub-assertion, which is the fifth assertion 108e. Furthermore as shown, the sixth assertion 108f depends on the third assertion 108c. The text 106″ includes a seventh assertion 108g while the text 106′″ includes an eight assertion 108h. The seventh assertion 108g in turn depends on the third assertion 108c.

Creating an assertion document 100′ by tagging the plurality of assertions in the text of software specification 100 is shown in the simplified diagram shown in FIG. 1B-1, in accordance with one embodiment of the present invention. The assertion document 100′ includes a specification box 150 and a plurality of chapter boxes 152 through 158, each corresponding to one of the chapters 102 through 104, respectively. The specification box 150 is designed to include information about the specification document 100 while assertion boxes 152 through 158 are configured to include information about all assertions included in the corresponding chapters 102 through 102′″.

In one embodiment, an assertion document type definition (“DTD”) is configured to provide an XML DTD for defining the assertion document. The XML DTD is designed to provide the test developers or the users the format of the assertion document. In one example, comments in the XML DTD provide additional requirements for the syntax and semantics of XML elements in the assertion document. Several exemplary XML elements are provided below:

Element spec: In one example, the spec element is configured to be the root of assertion.dtd. In one embodiment, the spec element defines the elements needed for expressing the specification document using the XML format. In one instance, the spec element requires the identification, name, version, define, and chapter+elements to describe the specification document. As designed, the name is configured to be the same as the name of specification document.

ID Element: In one example, the id element is configured to describe a unique characteristic of the element.

Name element: In one instance, the name element describes the name of the specification element. As designed, the name is configured to be unique when the name is used across more than one <define> element.

Version Element: According to one embodiment, the version element is configured to describe the version of the specification document.

Define Element: In one embodiment, the define element can be implemented to combine multiple assertion elements in a single assertion element. For instance, when an assertion covers more that one technology, the assertion writer may use the define element to refer to all the technologies. In one instance, a tool can be implemented to expand the assertion for each technology using the sub-assertion element. In one implementation, an assertion can use the define element by describing a <name-link> element in the value of the <name> element: For example, Table 1 includes an exemplary XML representation.

TABLE 1
Exemplary XML Representation

<assertion>

```
  <id>EJB:2.0_PFD2:1:2:2 </id>
  <name> /ejb/<name-link> Enterprise Beans
  </name-link>/ejbCreate
</name>
<description> ... </description>
...
```

</assertion>
<assertion>

```
  <id> EJB:2.0_PFD2:1:2:2 </id>
  <name> /ejb/<name-link> Enterprise Beans
  </name-link>/ejbCreate
</name>
<description> ... </description>
..
<sub-assertions>
```

<sub-assertion>

<id> EJB:2.0_PFD2:1.2.2#1 </id>
<name> /ejb/Statefull Session Bean/ejbCreate </name>
<description> ... </description>

</sub-assertion>
<sub-assertion>

<id> EJB:2.0_PFD2:1.2.2#2 </id>
<name>/ejb/BeanManagedPersistence/ejbCreate
</name>
<description> ... </description>

</sub-assertion>

</sub-assertions>

</assertions>

In this manner, once the <name-link> element is expanded, the define element can be removed from the assertion document.

Union Element: In one instance, the union element describes almost all the <name> elements used to describe the name of a higher level assertion.

Element Element: According to one embodiment, the element element defines the name of a sub-assertion.

Name-link Element: In one example, the name-link element is used in conjunction with the <define> element. In one instance, the name-link element can be configured to refer to a define name element.

Chapter Element: According to one embodiment, the chapter element is configured to contain almost all the information implemented to describe a specification document using XML. In one example, the name element is configured to be almost identical to the name of the associated specification. The description is configured to be a short sentence describing an overview of the chapter. In one example, a chapter can also define some assertions. However, in one instance, the assertions are configured to be defined at the section level.

Description Element: In one example, the description element contains a full description of the element. If the description element is used with the assertion element, the description element is configured to contain information describing the assertion in more detail. To the extent possible, the description is designed to be taken from the specification.

Section Element: In one example, the section element is configured to contain almost all the information required to describe a specification section. The name element is configured to be substantially the same as the specification section name. The description is designed to be a short sentence providing an overview of the section.

Assertions Element: In one instance, the assertions element is configured to describe almost all the elements required to be implemented to express a specification assertion using XML.

Assertion Element: In one instance, the assertion element is the XML view of a specification assertion. By way of example, the identification and the name elements are configured to be unique while the description is designed to be taken integrally from the specification document. In one embodiment, keywords can be used to describe an assertion and the spec-refs element can be used to refer to a different ID element. In one embodiment, if the assertion name includes a <define> element, the sub-assertion can be expanded by a tool or by the assertion writer.

An assertion can further include attributes to describe the state of the assertion. In one example, the following attributes are included:

type: In one embodiment, the type attribute defines the assertion type, which in one example, can be one of positive, negative, untestable or deprecated.

predef: In accordance with one embodiment, the predef element is an assertion that was defined earlier in the document, which in one example, is used in a different context. Some specification documents are configured to repeat the assertion at the beginning of a section, chapter, etc.

optional: In one example, an assertion can be optional. In one instance, an assertion attribute can be assigned to be either true or false. In one embodiment, when the specification includes certain recommendations regarding the assertion, the default attribute of an assertion is assigned to be false. Otherwise, in a different aspect, the assertion attribute is assigned to be true.

implementation_specific: In one example, an assertion can be product specific. In one example, the specification recommends a behavior of the assertion.

category: In one example, the category attribute is the characteristic of the assertion. For instance, the assertion can be classified under:

spec: In one embodiment, a specification assertion is an assertion that the entire product must realize. In one example, the specification assertion is configured to implement a specification feature uniformly throughout the specification. Usually, the description of the assertion contains words such as: “must,” “may,” “should,” etc. In one example, optional or implementation specific assertions can also be marked as spec assertions.

usage: In one instance, the usage attribute is used when an assertion contains a sub-assertion using the <depend> element. In one example, the usage assertion is designed to address a more complex scenario than a spec assertion.

Algorithm: In one instance, the algorithm is an assertion that represents an algorithm.

According to one example, an assertion writer takes the following items in consideration:

In one instance, when possible, the assertion description is configured to be taken from the specification without changing the wording.

In one embodiment, a usage assertion is composed of more than one specification assertion.

For instance, a high level assertion uses the predef element to refer to the assertion it is describing.

In one example, if an assertion description contains must, should, may, etc., the assertion is an spec assertion.

In accordance to one implementation, substantially all assertions should be represented within the assertion document even if the assertion is difficult to test.

By way of example, the keyword element is configured to be used as many time as possible. In one embodiment, an assertion can have more than one keyword associated with it.

In one instance, in an attempt to avoid duplication, the assertion writer is configured to confirm that the assertion was not previously defined in the document.

Keywords Element: In accordance with one embodiment, the keywords element is configured to define a set of keywords associated with an assertion. In one instance, a tool or XSLT Stylesheet can be used to extract assertions based on the keywords.

Keyword Element: In one embodiment, the keyword element is designed to describe a keyword associated with an assertion. According to one embodiment, a tool or XSLT Stylesheet can be used to extract assertions based on their respective keywords.

Spec-refs Element: In one example, the spec-refs element is configured to describe a secondary ID for the assertion. For instance, an assertion can have a plurality of identifications referenced in the <spec-ref> element. In one embodiment, the <id> element can be referenced using the <spec-ref> element. An exemplary spec-refs is provided below in Table 2.

TABLE 2
Exemplary XML Representation Using XML

<id> J2EE:1.3:1:1.1 </id>
<spec-refs>

<spec-ref> j2ee:1.2:1:1.2 </spec-ref>

<spec-refs>

Spec-ref Element: In one example, the spec-ref element is configured to describe a different <id> implemented to reference an assertion. In one embodiment, the identifications can be used when the specification is revised.

In one embodiment, the assertion document may not contain any links to the XSLT Stylesheet file. In such a scenario, a tool capable of transforming the XML assertion document into another document having a different format (ex: html) is configured to be used.

In accordance to one embodiment, an exemplary XML DTD is provided in Table 3.

TABLE 3
Exemplary XML DTD for an Assertion Document

<!--
This is an example of the XML DTD for assertion documents.
-->

<?xml version=“1.0” encoding=“UTF-8”?>
<!DOCTYPE spec SYSTEM

‘http://sardinia.sfbay:8080/ejte/assertion/dtds/assertions.dtd’>
<!--
In accordance with one example, the spec element is the root of assertion.dtd. It
defines the elements needed for expressing the specification document using XML
format. The name is the same as the specification document.
-->
<!ELEMENT spec (id, name, version, define*, chapter+)>
<!--
The id element describes the unique id of an element.
Used in: spec, chapter, section, assertion, sub-assertion, and define
-->
<!ELEMENT id (#PCDATA)>
<!--
In one example, the name element describes the name of the specification element.
The name is configured to be unique when it is used across more than one <define>
element.
Used in: spec, chapter, section, assertion, sub-assertion, and define
-->
<!ELEMENT name (#PCDATA | name-link)*>
<!--
By way of example, the version element describes the version of the specification
document.
Used in: spec
-->
<!ELEMENT version (#PCDATA)>
<!--
In accordance with one embodiment, the define element is used to combine multiple
assertion <name> element in a single assertion. When an assertion covers more that
one technology, the assertion writer may use the define element to reference all the
technologies. Later, a tool can expand each technology assertion using the sub-
assertion element. For instance:

<define>

<id> EJB:1 </id>
<name> Enterprise Beans </name>
<union>

<element> Stateless Session Bean </element>
<element> Stateful Session Bean </element>
<element> Bean Managed Persistence </element>
<element> Container Managed Persistence </element>
<element> Message-Driven Bean </element>

</union>

</define>

In accordance with one embodiment, an assertion can use the define element by
defining a <name-link> element in the <name> value:

<assertion>

```
  <id>EJB:2.0_PFD2:1:2:2 </id>
  <name>  /ejb/<name-link>  Enterprise Beans </name-
link>/ejbCreate</name>
<description> ... </description>
....
```

</assertion>

Thereafter, a tool can be used to expand the <define> element:

<assertion>

```
  <id> EJB:2.0_PFD2:1:2:2 </id>
  <name> /ejb/<name-link> Enterprise Beans </name- link>/ejbCreate
</name>
<description> ... </description>
...
<sub-assertions>
```

<sub-assertion>

<id> EJB:2.0_PFD2:1.2.2#1 </id>
<name> /ejb/Statefull Session Bean/ejbCreate </name>
<description> .... </description>

</sub-assertion>
<sub-assertion>

<id> EJB:2.0_PFD2:1.2.2#2 </id>
<name>/ejb/BeanManaged
Persistence/ejbCreate</name>
<description> .... </description>

</sub-assertion>

</sub-assertions>

</assertions>

It must be noted that in one example, although not required, once the <name-link>
element has been expanded, the define element can be removed from the document.
Used in: name
-->
<!ELEMENT define (id, name, description, union)>
<!--
In one example, the union element describes the <name> elements used to describe a
higher level assertion name.
Used in: define
-->
<!ELEMENT union (element+)>
<!--
In accordance to one embodiment, the element defines the name of a sub-assertion.
Used in: union
-->
<!ELEMENT element (#PCDATA)>
<!--
According to one embodiment, the name-link element is used in conjunction with a
<define> element. The name-link element references a define name element.
Used in: name
-->
<!ELEMENT name-link (#PCDATA)>
<!--
In one example, the chapter element contains almost all the required information used
to describe a chapter in the specification document using XML. The name element is
the associated specification chapter name. The description is configured to be a short
sentence describing an overview of the chapter. In one embodiment, although
assertions are defined at the section level, a chapter can also define some assertions.
Used in: spec
-->
<!ELEMENT chapter ( id, name, description, assertions?, section*, spec-refs? )>
<!--
In accordance to one embodiment, the description element contains a full description
of the element. In one example, when used with the assertion element, the description
contains information describing the assertion in detail. If possible, the description is
taken integrally from the specification.
Used in: spec, chapter, section, define, assertion, and sub-assertion.
-->
<!ELEMENT description (#PCDATA)>
<!--
In one instance, the section element contains the required information to describe a
specification section using XML. The name element is configured be the name of
specification section. The description can be a short sentence providing an overview
of the section.
Used in: chapter
-->
<!ELEMENT section ( id, name, description, assertions?, spec-refs? )>
<!--
In one example, the assertions element describes the required elements used for
expressing a specification assertion using XML.
Used in: chapter and section.
-->
<!ELEMENT assertions ( depends*, assertion* )>
<!--
In one example, the assertion element is an XML view of a specification assertion.
The id and the name elements are configured to be unique while the description is
designed to be taken integrally from the specification. Keywords can be used to
describe an assertion. <spec-refs> can be used to refer to a different ID element. In
accordance with one implementation, if the assertion name uses a <define> element,
sub-assertion can be expanded by a tool or the assertion writer. An assertion may also
have the following attributes used for describing the state of the assertion:

type: In one instance, the type attribute defines the assertion type (e.g.,
positive, negative, untestable, deprecated, etc.)
predef: By way of example, an assertion can be defined earlier in the
document and be used in a different context later on in the document. In
accordance to one embodiment, the specification document repeats the
assertion at the beginning of a section, a chapter, etc.
optional: In one instance, an assertion can be optional (e.g., true or false).
implementation_specific: According to one embodiment, an assertion can be
product specific.
Category: In one instance, the category is the category under which the
assertion can be classified. By way of example, the assertion can be classified
under:

Spec: In one instance, a specification assertion is an assertion that
products realize. Usually, the assertion description contains words
such as “MUST,” “MAY,” “SHOULD,” etc. According to one
example, optional or implementation specific assertions can also be
marked as a spec assertion.
Usage: In one embodiment, the usage assertion is an assertion that
contains a sub-assertion which uses the <depend> element. By way
of example, the usage assertion can consist of a more complex
scenario than a spec assertion.
Algorithm: In one embodiment, the algorithm assertion is an
assertion that represents an algorithm.

Used in: assertions
-->
<!ELEMENT assertion (id, name, description, depends*, spec-refs?, sub-assertions*,
keywords* )>
<!ATTLIST assertion

type ( positive | negative | deprecated | untestable) “positive”
predef CDATA #IMPLIED
optional (true | false) “false”
implementation_specific (true | false) “false”
category (spec | usage | algorithm ) #IMPLIED>

<!--
In one instance, the keywords element defines a set of keywords associated with an
assertion. A tool or XSLT Stylesheet can be used to extract assertions based on the
keywords.
Used in: assertion
-->
<!ELEMENT keywords (keyword+)>
<!--
In one instance, the keyword element describes a keyword associated with the
assertion. A tool or XSLT Stylesheet can be used to extract assertions based on their
respective keywords.
Used in: keyword
-->
<!ELEMENT keyword (#PCDATA)>
<!--
In one example, the depends element contains all the dependencies of an assertion, a
section, a chapter, etc. The depend element is used to describe a scenario in which a
second assertion can be realized after a first assertion has been realized.

<assertion>

```
  <id> EJB:2.0_PFD2:1:2:2 </id>
  <name> /ejb/<name-link> Enterprise Beans </name-link>/ejbCreate
</name>
<description> ... </description>
.<depends>
```

<depend> EJB:2.0_PFD2:1:1:1 </depend>

</depends>

</assertion>

Used in: chapter, section, and assertion.
-->
<!ELEMENT depends (depend+)>
<!--
By way of example, the depends order attribute is used when the execution of one
assertion follows the execution of multiple assertions. Ex:

Assertion 3 must always occur after assertion 1 and assertion 6

<depends order=“assertion 1, assertion 6”>

<depend> assertion 1 </depend>
<depend> assertion 6 </depend>

</depends>

Used in: depend
-->
<!ATTLIST depends

order CDATA #IMPLIED>

<!--
In one example, the depend element describes the dependency of an assertion on
another assertion. In one instance, the element value is an assertion <id> value.
Used in: depends
-->
<!ELEMENT depend (#PCDATA)>
<!--
In one example, the spec-refs element describes a secondary ID for the assertion. An
assertion can have multiple id(s) referenced in the <spec-ref> element.

<id> J2EE:1.3:1:1.1 </id>
<spec-refs>

<spec-ref> j2ee:1.2:1:1.2 </spec-ref>

<spec-refs>

In one embodiment, the <id> element can be referenced using the <spec-ref> element.
Used in: assertion
-->
<!ELEMENT spec-refs (spec-ref+)>
<!--
According to one implementation, the spec-ref element describes a different <id> used
for referencing an assertion. These IDs can be used when the specification changes.
Used in: spec-refs
-->
<!ELEMENT spec-ref (#PCDATA)>
<!--
In one instance, the sub-assertions element is used to expand an assertion name that
contains a <name-link> element to a <define> element. The spec-ref element can be
defined manually (i.e., meaning without using a tool, the define element, or the name-
link element).
Used in: assertion
-->
<!ELEMENT sub-assertions (sub-assertion+)>
<!--
In one example, the sub-assertion element expands an assertion based on the <define>
element. The ID of a sub-assertion follows the following rule:

<assertion parent is> + # + unique id

Ex:

<assertion>

```
  <id> EJB:2.0_PFD2:1:2:2 </id>
  <name> /ejb/<name-link> Enterprise Beans </name-
link>/ejbCreate</name>
<description> ... </description>
..
<sub-assertions>
```

<sub-assertion>

<id> EJB:2.0_PFD2:1.2.2#1 </id>
<name> /ejb/Statefull Session Bean/ejbCreate </name>
<description> .... </description>

</sub-assertion>
<sub-assertion>

<id> EJB:2.0_PFD2:1.2.2#2 </id>
<name>/ejb/BeanManaged
Persistence/ejbCreate</name>
<description> .... </description>

</sub-assertion>

</sub-assertions>

</assertions>

-->
<!--
In one example, the sub-assertion element is an XML view of a specification assertion.
According to one embodiment, the id and the name element are unique and the
description is taken integrally from the assertion that the sub-assertion is realized. In
one instance, a sub-assertion has attributes used for describing the state of the
assertion:

type: In one example, the type element defines the sub-assertion type (e.g.,
positive, negative, untestable, deprecated, etc.)
predef: In one embodiment, a sub-assertion can be defined earlier in the
document and be used in a different context later on in the document. By way
of example, some specification documents repeat the sub-assertion at the
beginning of a section, chapter, etc.
optional: In one example, a sub-assertion can be optional (e.g., true or false).
implementation_specific: In accordance to one embodiment, a sub-assertion
can be product specific.
Category: By way of example, the category under which the assertion can be
categorized. According to one implementation, the sub-assertion can be
classified under:

spec: In one example, a specification sub-assertion is an assertion
that products realize. Usually, the sub-assertion description
contains words like “MUST,” “MAY,” “SHOULD,” etc. Optional
or implementation specific assertions can also be marked as spec
assertions.
usage: In accordance to one embodiment, the usage assertion is an
assertion that contains a sub-assertion which uses the <depend>
element. The usage assertion can consist of a more complex
scenario than a spec assertion.
Algorithm: A sub-assertion that represents an algorithm.

Used in: assertion
<!ELEMENT sub-assertion (id, name, description?)>
<!ATTLIST sub-assertion

type ( positive | negative | deprecated | untestable) “positive”
predef CDATA #IMPLIED
optional (true | false) “false”
implementation_specific (true | false) “false”

With a continued reference to FIG. 1B-1, in one example, the assertion writer is configured to include the following information about the specification document 100 in the specification box 150:

Specification name: In one example, the assertion writer is configured to assign a logical name to each specification document;

Specification id: In one embodiment, the assertion writer is configured to assign an ID to each specification document. The ID is designed to be unique across an assertion document. An exemplary ID is:

ejb (for Enterprise Java bean)

Specification version: In one instance, the assertion writer is configured to assign a unique specification version for each assertion document. In one example it is the specification version.

Table 4 includes the contents of the specification box 150.

TABLE 4
Exemplary XML Representation in a Specification Box

<spec>

<id> Java Server Pages <id>
<name> Java Server Pages </name>
<version> 1.2_PDF1 </version>
<description> The JSP is compiled into a servlet </description>

</spec>

The contents of exemplary assertion boxes 152 through 158 are discussed in more detail below with respect to FIGS. 1B-2 through 1B-5.

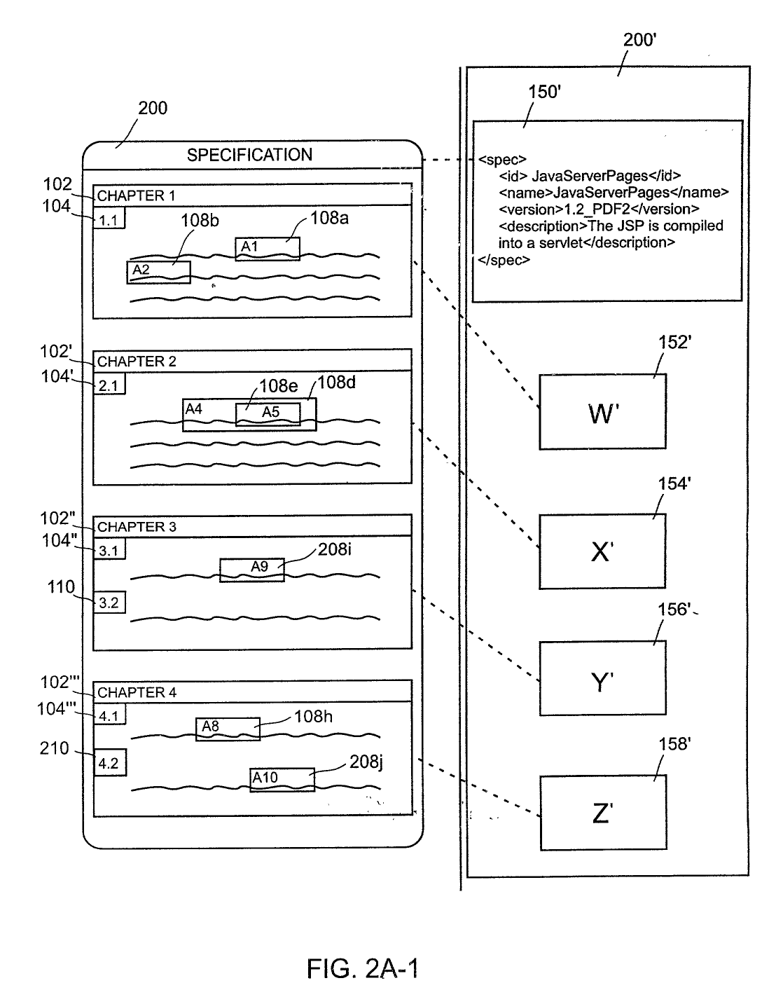

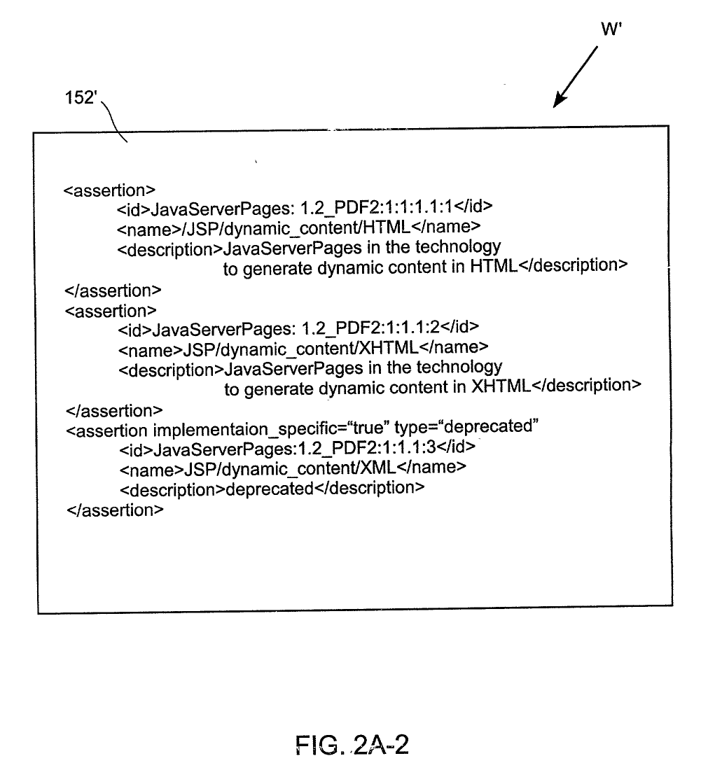

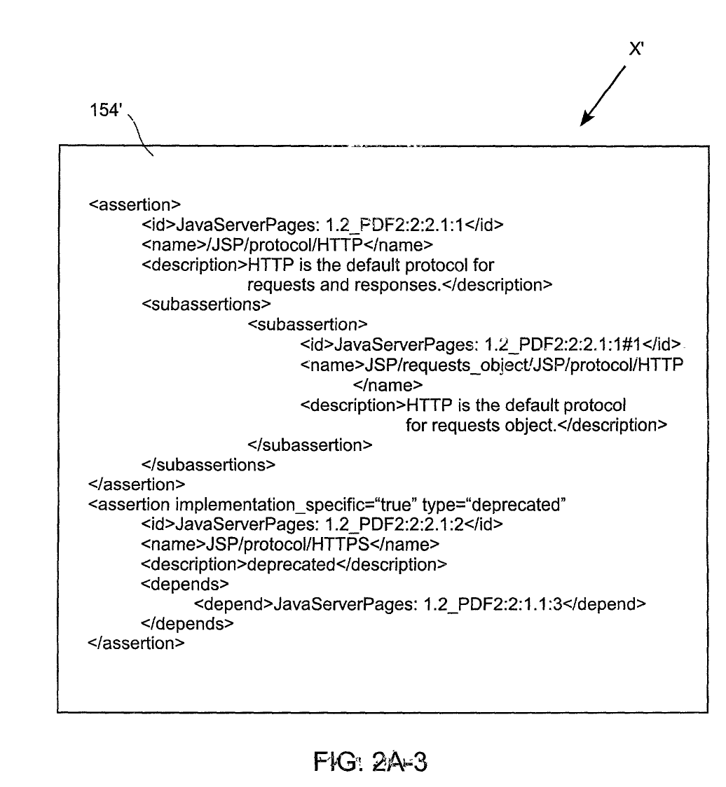

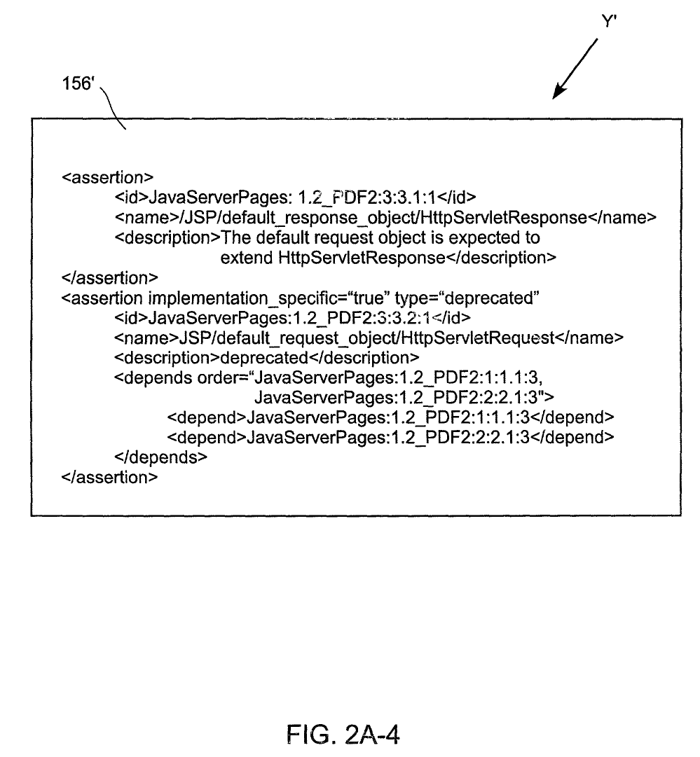

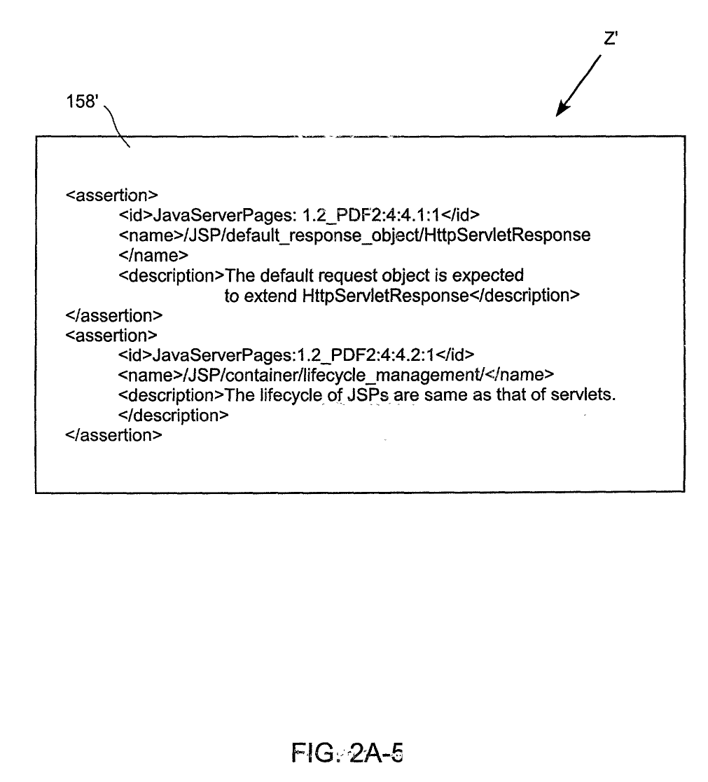

FIG. 1B-2 depicts the contents of an assertion box 152, in accordance with one embodiment of the present invention. In one example, an assertion box is configured to include the following information:

Chapter name: In one example, the assertion writer is configured to re-use the specification chapter name when creating the assertion document. The chapter name is configured to be the same for both, the specification document and the assertion document.

Chapter id: In one instance, the assertion writer is configured to re-use the specification chapter number when creating the assertion document. The chapter id is designed to be the same for both specification and assertion document. The chapter id is designed to be unique.

Section name and sub-section name: In one implementation, the assertion writer is configured to re-use the specification section name or sub-section name when creating the assertion document. By way of example, the section name (or sub-section name) is designed be the same for both the specification and the assertion document.

Section id and sub-section id: In one embodiment, the assertion writer is configured to re-use the specification section number when creating the assertion document. The section id is designed to be the same for both the specification and assertion documents. Again, the section id is designed to be unique. In one instance, the uniqueness of the section id and subsection id is configured to be across the same section and same subsection elements within one particular chapter element.

Assertion name and sub-assertion name: In one example, the assertion writer is configured to assign a name to each of the assertions. The name is designed to be based on the descriptors such as: specification, technology, operation to achieve, etc. In one instance, each descriptor is configured to be separated using the “/” character. An example is:

/ejb/entity bean/container managed persistence/ejbLoad

Assertion id and sub-assertion id: By way of example, the assertion writer is configured to assign a unique id to an assertion. The id is designed to be based on the specification id, the specification chapter, and the specification section where the assertion is defined.

Assertion keyword and sub-assertion keyword: In one example, the assertion writer may assign one or more keywords to an assertion. The keyword is configured to be based on certain criteria such as a behavior of the specification, the technology, etc.

Chapter, section and assertion ID definition: In one instance, the rule depicted in Table 5 is followed to define an element ID. In one example, this rule may not be applied to define a sub-assertion ID:

TABLE 5
Exemplary Assertion Rule

Specification ID:
Specification version + “_” + Specification release version:
Chapter number:
Section or sub-section number:
Unique ID:

An exemplary element ID is:

EJB:2.0_PFD2:1:1:1

Sub-assertion ID definition: In one instance, the rule in Table 6 is configured to be followed when defining a sub-assertion ID:

TABLE 6
Exemplary Assertion Rule

Specification ID:
Specification version + “_” + Specification release version:
Chapter number:
section number:
assertion unique ID + “#” + unique ID for sub-assertion

In one example, it is recommended to assign a unique ID number starting from 0, 1, 2 . . . . An exemplary sub-assertion is:

EJB:2.0_PFD2:1:1:1#5

Referring back to FIG. 1B-2, representing the first, second, and third assertions 108a through 108c using the XML tags can further be understood, in accordance with one embodiment. In one example, the XML representation of the first assertion 108a is shown in Table 7.

TABLE 7
Exemplary First Assertion XML Tags

<assertion>

<id> Java Server Pages: 1.2_PDF1:1:1.1:1 </id>
<name> /JSP/dynamic-content/HTML </name>
<description> Java Server Pages in the
technology to generate dynamic

content in HTML </description>

</assertion>

In a like manner, Table 8 contains the exemplary XML tag codes for the second assertion 108b and the third assertion 108c.

TABLE 8
Exemplary XML Representation

</assertion>

<id> Java Server Pages: 1.2_PDF1:1:1.1:2 </id>
<name> JSP/dynamic-content/XHTML </name>
<description> Java Server Pages in the
technology to generate dynamic

content in XHTML </description>

</assertion>
</assertion>

<id> Java Server Pages: 1.2_PDF1:1:1.1:3 </id>
<name> JSP/dynamic-content/XML </name>
<description> Java Server Pages is the
technology to generate dynamic

content in XML </description>

</assertion>

Referring now to FIG. 1B-3, XML representation of the assertions contained within the chapter 104′ can be further be understood, in accordance to one embodiment of the present invention. As illustrated, the fifth assertion 108e is the sub-assertion of the fourth assertion 108d. As used herein, the sub-assertion element is configured to expand an assertion using the <define> element. In one instance, the sub-assertion element is an XML view of an assertion in the specification document. In one example, the id and the name element of the sub-assertion is configured to be unique. Furthermore, in one instance, the description of the sub-assertion is taken integrally from the assertion the sub-assertion depends on.

In one embodiment, a sub-assertion ID may be designed to follow the rule in Table 9:

TABLE 9
Exemplary Sub-assertion Rule

<assertion parent id> + # + unique id

By way of example, the XML representation of the fourth assertion 108d and the sub-assertion 108e is shown in Table 10.

TABLE 10
Exemplary XML Sub-assertion Representation

<assertion>

<id> Java Server Pages: 1.2_PDF1:2:2.1:1 </id>
<name> /JSP/protocol/HTTP </name>
<description> HTTP is the default protocol for requests and responses
</description>

<subassertions>

<subassertion>

<id> Java Server Pages: 1.2_PDF1:2:2.1:# </id>
<name> JSP/Requests/JSP/Protocol/HTTP </name>
<description> HTTP is
the default protocol for requests
</description>

</subassertion>

</subassertions>

</assertion>

In one implementation, the sub-assertion can be designed to have attributes to describe the state of the assertion. In one example, the sub-assertion has the following exemplary attributes:

type: In one example, the type attribute defines the sub-assertion type, which may be positive, negative, untestable, or deprecated.

predef: In one instance, a sub-assertion can be earlier defined in the document (i.e., duplicate) can be used in a different context. By way of example, some specification documents are designed to repeat the sub-assertion at the beginning of each section, chapter, etc.

optional: In one implementation, a sub-assertion can be designed to be optional. That is, the sub-assertion can be assigned a value of either true or false.

implementation_specific: By way of example, the sub-assertion can be configured to be product specific.

category: In one instance, the sub-assertion can be classified under the same category as the assertion. By way of example, the subassertion can be classified as:

spec: In one embodiment, a specification sub-assertion is an assertion that substantially all products must realize. In one instance, the sub-assertion description can be configured to contain words such as “MUST,” “MAY,” “SHOULD,” etc. In one implementation, optional or implementation specific implementation can also be marked as spec assertion;

usage: In one instance, an assertion containing a sub-assertion implements the <depend> element. According to one embodiment, the <depend> element is configured to be a more complex scenario than a spec assertion; and

algorithm: In one embodiment, algorithm assertion is a sub-assertion configured to represent an algorithm.

An exemplary multi sub-assertion XML representation is shown in Table 11.

TABLE 11
Exemplary Multi-sub-assertion XML Representation

<assertion>

<id> EJB:2.0_PFD2:1:2:2 </id>
<name> /ejb/<name-link>
Enterprise Beans </name-
link>/ejbCreate</name>
<description> ... </description>
..
<sub-assertions>

<sub-assertion>

<id> EJB:2.0_PFD2:1.2.2#1 </id>
<name> /ejb/Statefull Session Bean/ejbCreate </name>
<description> .... </description>

</sub-assertion>
<sub-assertion>

<id> EJB:2.0_PFD2:1.2.2#2 </id>
<name>/ejb/BeanManaged
Persistence/ejbCreate</name>
<description> .... </description>

</sub-assertion>

</sub-assertions>

</assertions>

-->

Furthermore, as discussed with respect to FIG. 1B-1, the sixth assertion 108f depends on the third assertion 108c requiring the execution of the third assertion 108c prior to the execution of the sixth assertion 108f. In one example, the dependency of one assertion on a different assertion is shown implementing the <depends> element. By way of example, dependency of the sixth assertion 108f on the third assertion 108c is shown in Table 12.

TABLE 12
Exemplary Assertion Dependency

<assertion>

<id> Java Server Pages: 1.2_PDF1:2:2.1:2 </id>
<name> JSP/Protocol/HTTPS </name>
<description> HTTP is the secure protocol for requests and responses

that JSP also supports </description>

<depends>

<depend> Java Server Pages: 1.2_PDF1:2:1.1:3 </depend>

<depends>

</assertion>

In one instance, the depends element contains almost all the dependencies of an assertion, a section, or a chapter. By way of example, first assertion is required to be executed before a second assertion can be executed. As shown in Table 13, in one embodiment, the depend element is used to describe the dependency an assertion can have on another assertion. As designed, the element value is configured to be an assertion <id> value.

TABLE 13
Exemplary XML Representation Using the Depend Element

<assertion>

<id> EJB:2.0_PFD2:1:2:2 </id>
<name> /ejb/<name-link>
Enterprise Beans </name-
link>/ejbCreate</name>
<description> ... </description>
.<depends>

<depend> EJB:2.0_PFD2:1:1:1 </depend>

</depends>

</assertion>

Referencing to FIG. 1B-4, an XML representation of a multi-assertion dependency is illustrated in more detail, in accordance with one embodiment of the present invention. As shown, the seventh assertion 108g can be executed after the sixth assertion 108f has been executed. In turn, the sixth assertion 108f can be executed after the third assertion 108c has been executed. Thus, the seventh assertion 108g is executed after the third assertion 108c and the sixth assertion 108g have been executed.

The <depends order> attribute can be used to describe the scenario in which the execution of one assertion is designed to follow the execution of more than one assertions. An exemplary XML representation implementing <depends order> is shown in Table 14. In this scenario, an assertion “g” is configured to occur after assertion “a” and assertion “d.”

TABLE 14
Exemplary XML Representation

<depends order=“assertion a, assertion d”>

<depend> assertion b </depend>
<depend> assertion c</depend>

</depends>

Thus, the XML representation of the seventh assertion is described below in Table 15.

TABLE 15
Exemplary XML Representation of Assertion 7

<assertion>

<id> Java Server Pages: 1.2_PDF1:3:3.2:1 </id>
<name> JSP/default-request-object/HTTP Servlet Request </name>
<description> The default request object is expected to extend
HTTP Servlet Request </description>
<depends order = “Java Server Pages: 1.2_PDF1:1:1.1:3,

Java Server Pages: 1.2_PDF1:2:2.1:3”>

<depend> Java Server Pages: 1.2_PDF1:1:1.1:3 </depend>
<depend> Java Server Pages: 1.2_PDF1:2:2.1:3 </depend>

</depends>

</assertion>

The XML representation of the eighth assertion 108 is shown in FIG. 1B-5, in accordance with one embodiment of the present invention. As also shown in Table 16, the eight assertion is located in section 1.2 of chapter 4.

TABLE 16
XML Representation of Assertion 8

</assertion>

<id> Java Server Pages: 1.2_PDF1:4:4.1:1 </id>
<name> JSP/default-response-object/HHpServlet Response </name>
<description> The default request object is
expected to extend HHpServlet
Response </description>

</assertion>

FIG. 2A-1 illustrates a first revised specification 200 of the specification 100, in accordance with one embodiment of the present invention. As shown, while the first revised specification 200 still includes chapters 102 through 102′″, certain modifications have been made to the assertions and sections. By way of example, the third assertion 108c of the specification 100 has been deleted in the first revised version 200, while the assertions 108a and 108b of section 1.1 104 have remained unchanged. Section 2.1 104′ of chapter 102′ only includes the fourth assertion 108d and the fifth assertion 108e. Since the third assertion 108c has been deleted in the specification 200, all depending assertions (i.e., the sixth assertion 108f and the seventh assertion 108g) have also been deleted. Thus, as shown, the sixth assertion 108f has been deleted in the first revised specification 200.

Section 3.2 110 of chapter 3 102″ has been modified since the seventh assertion 108g has been deleted in the first revised specification 200. In addition to deleting the seventh assertion 108g, a new ninth assertion 208j has been added to the section 3.1 104″ of chapter 3. In a like manner, the assertion 108h of section 4.1 of 104′″ in chapter 102′″ has remained unchanged.

The revised assertion document 200′ includes a plurality of boxes 150′, W′ 152′, X′ 154′, Y′ 156′, and Z′ 158′. The box 150′ includes the XML representation of the first revised specification 200, which for the most part is similar to the XML representation of the specification in the box 150 of FIG. 1A-2. However, the XML representation of the first revised specification as depicted in box 150′ contains information conveying the version of the specification. Specifically, the version number in the box 150 of FIG. 1A-2 is shown to be “1.2_PDF1” (i.e., original specification), while the version number in the box 150′ is shown to be “1.2_PDF2” (i.e., the first revised specification).

Reference is made to FIG. 2A-2 depicting the XML representation of the first, second, and third assertions 108a-c of the first revised specification 200, in accordance with one embodiment of the present invention. As shown, the <id> of each assertion has been modified so as to include the revision number “PDF2,” rather than “PDF1,” as illustrated in FIG. 1A-3. Furthermore, since the third assertion 108c has been deleted, the XML representation of the third assertion 108c has been changed to reflect the elimination of the assertion. Specifically, the <description> of the third assertion 108c has been changed to reflect the deprecated status of the third assertion 108c. Furthermore, the third assertion 108c is marked to be <assertion implementation_specific>, which in one embodiment is configured to convey the behavior of the assertion. The XML representation of the third assertion 108c is shown in Table 17.

TABLE 17
Exemplary XML Representation of a Deleted Assertion

<assertion>
<assertion implementation-specific=“true” type=“deprecated”>

<id> Java Server Pages: 1.2_PDF2:1:1.1:3 </id>
<name> JSP/dynamic-content/XML </name>
<description> deprecated </description>

</assertion>

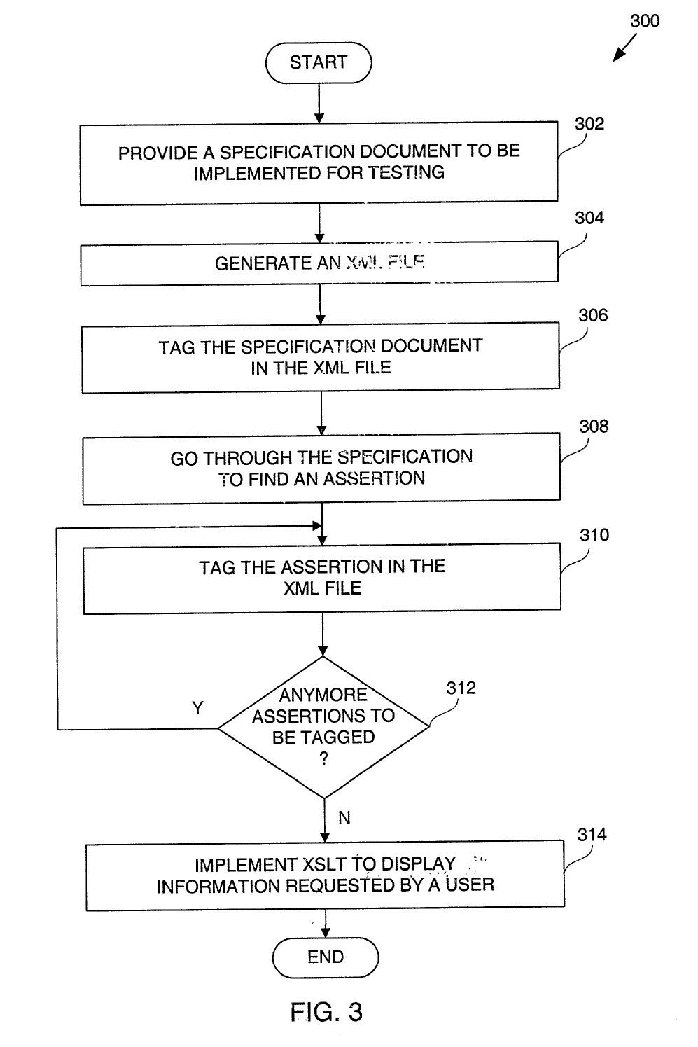

Reference is now made to FIG. 2A-3 in which XML representation of the fourth through sixth assertions 108d-108f of the first revised specification are shown, in accordance with one embodiment of the present invention. As discussed in more detail above, the XML representation of the sixth assertion 108f is modified to reflect the removal of the sixth assertion 108f. As shown, the sixth assertion 108f has not been entirely removed from the representation. Simply, the description of the sixth assertion has been changed to reflect the elimination of the assertion. In one example, the eliminated assertions remain in the XML assertion document despite their eliminated status to simplify keeping track of modifications, deletions, and additions through the repeated modifications to the specification. Table 18 shows an exemplary XML representation of the sixth assertion 108f as deleted.

TABLE 18
Exemplary XML Representation of the Deleted Sixth Assertion

<assertion implementation-specific = “true” type = “deprecated”>
<id> Java Server Pages: 1.2_PDF2: 2:2.1:2 </id>
<name> JSP/Protocol/HTTPS </name>
<description> deprecated </description>
<depends>

<depend> Java Server
Pages: 1.2_PDF2:2:1.1:3 </depends>

</depends>

</assertion>

FIG. 2A-4 shows the XML representation of the seventh assertion 108g and a new ninth assertion 208i, in accordance with one embodiment of the present invention. The ninth assertion 208i has been added to the section 3.1 104″ of chapter 3 while the seventh assertion 108g has been deleted due to the elimination of the sixth assertion 108f. As shown, the XML representation of the ninth assertion 208i easily conveys to a test developer that the ninth assertion 208i was not included in the initial XML representation document 100′ and that it has been added in the first revised specification 200. Specifically, this information is conveyed as the <id> number for the ninth assertion 208i is higher than the <id> number of the seventh assertion 108g, despite the assertion nine 208i being defined in the section 3.1 104″ of chapter 3 102″ and the seventh assertion 108g being defined in the section 3.2 110 of the chapter 3 102″. In the same manner, the deprecated status of the seventh assertion 108g informs the test developers of the elimination of the seventh assertion 108g in the first revised specification 200. The XML representation of the assertions in chapter 3 102″ is shown below in the Table 19.

TABLE 19
Exemplary XML Representation

<assertion>

<id> Java Server Pages: 1.2_PDF2: 3:3.1:1 </id>
<name> JSP/default-response-object/HHpServletResponse </name>
<description> The default request object
is expected to extend HHpServlet
Response </description>

</assertion>
<assertion implementation-specific = “true” type = “deprecated”>

<id> Java Server Pages: 1.2_PDF2:3:3.2:1 </id>
<name> JSP/default-request-object/HHpServlet Request </name>
<description> deprecated </description>
<depends order = “Java Server Pages: 1.2_PDF2:1:1.1:3,

Java Server Pages: 1.2_PDF2:2:2.1:3”>

```
    <depend> Java Server Pages: 1.2_PDF2:1:1.1:3 </depend>
    <depend> Java Server Pages: 1.2_PDF2:2:2.1:3 </depend>
```

</depends>

</assertion>

FIG. 2A-5 is the XML representation of the eight assertion 108h and the newly added tenth assertion 208j, in accordance with one embodiment of the present invention. Although the eight assertion 108h has remained unchanged, the chapter 4 102′″ of the first revised specification 200 contains a new section 4.2 210 which includes the new tenth assertion 208j. Again, a comparison of the XML representation of box 158′ and the XML representation of box 158 easily reveals that the tenth assertion 208j was added in the first revised specification 200.

An exemplary XML representation of a specification is shown below in Table 20.

TABLE 20
Excerpts of an XML Representation of a Specification

<?xml-stylesheettype=“text/xsl”
href=“http://javaweb.sfbay/˜ja120114/xsl/assertions.xsl”?>
<!DOCTYPE spec SYSTEM “http://javaweb.sfbay/˜ja120114/dtds/assertions.dtd”>
<!-- The pattern use to define ID is: specs:version:chapter:section:local id -->
<spec>

<id> JavaServerPages </id>
<name> JavaServerPages </name>
<version> 1.2 </version>
<define>

<id> JavaServerPages:1.2_PFD2:1 </id>
<name> page_implementation </name>
<description>The JSP page is compiled into a servlet</description>
<union>

<element>servlet</element>

</union>

</define>
<define>

<id> JavaServerPages:1.2_PFD2:2 </id>
<name>_Actions </name>
<description>The JSP page is composed of elements and template text,

the Action element is one them</description>

<union>

<element> element/action/standard/ </element>
<element> element/action/custom/ </element>

</union>

</define>
<define>

<id> JavaServerPages:1.2_PFD2:3 </id>
<name>_Scripting </name>
<description>Scripting is another element that comprises the JSP

</description>

<union>

<element> element/scripting/declaration </element>
<element> element/scripting/scriptlets </element>
<element> element/scripting/expressions </element>

</union>

</define>
<define>

<id> JavaServerPages:1.2_PFD2:4 </id>
<name>_Out </name>
<description>The out object represent a media to flush the data out to

the user agent.</description>

<union>

<element>

output_stream/JSPWriter/exposed_through_implicit_object/out_object </element>

</union>

</define>
<define>

<id> JavaServerPages:1.2_PFD2:5 </id>
<name> ExplicitObject </name>
<description>Explicit object are Java Beans /objects that are

instantiated in the JSP</description>

<union>

<element> element/explicit/server-side_object </element>
<element> element/explicit/JavaBean </element>

</union>

</define>
<define>

<id> JavaServerPages:1.2_PFD2:6 </id>
<name>_ImplicitObject </name>
<description>Implicit objects are available as variables that encapsulate

the basic </description>

<union>

<element>jsp_page/implicit </element>

</union>

</define>
<define>

<id> JavaServerPages:1.2_PFD2:7 </id>
<name>_Attributes </name>
<description>Attributes</description>
<union>

<element> /page/element/directive/attribute </element>
<element> /page/element/scripting/attribute </element>
<element> /page/element/action/attribute </element>

</union>

</define>
<define>

<id> JavaServerPages:1.2_PFD2:8 </id>
<name>_ID </name>
<description/>
<union>

<element>_Attributes/request_time/ID </element>
<element>_Attributes/page_translation_time </element>

</union>

</define>
<define>

<id> JavaServerPages:1.2_PFD2:9 </id>
<name> StandardActionElements </name>
<description> StandardActionElements </description>
<union>

<element> jsp:useBean </element>
<element> jsp:setProperty </element>
<element> jsp:getProperty </element>
<element> jsp:include </element>
<element> jsp:forward </element>
<element> jsp:param </element>
<element> jsp:params </element>
<element> jsp:plugin </element>
<element> jsp:text </element>

</union>

</define>
<define>

<id> JavaServerPages:1.2_PFD2:10 </id>
<name> JSPDocument </name>
<description>JSP in XML Syntax</description>
<union>

<element> JSP page in XML syntax </element>

</union>

</define>
<define>

<id> JavaServerPages:1.2_PFD2:11 </id>
<name> XMLView </name>
<description>XML view of a JSP Page</description>
<union>

<element> XML document from a JSP page </element>

</union>

</define>
<define>

<id> JavaServerPages:1.2_PFD2:12 </id>
<name>_TagHandlers </name>
<description>Tag Handlers are classes used to implement custom

actions</description>

<union>

<element>element/java_classes/TagHandler/implement/Tag
</element>
<element>
element/java_classes/TagHandler/implement/IterationTag
</element>

<element> element/java_classes/TagHandler/implement/BodyTag </element>

<element> element/java_interface/TagHandler/TryCatchFinally

</element>

<element>

/jsp/page/element/java_classes/TagHandler/TagSupport </element>

<element>

/jsp/page/element/java_classes/TagHandler/BodyTagSupport </element>

</union>

</define>
<define>

<id> JavaServerPages:1.2_PFD2:13 </id>
<name> XMLElements </name>
<description>elements of JSP Page in XML </description>
<union>

<element> jsp:root_element </element>
<element> directive_element </element>
<element> scripting_element </element>
<element> standard_action_element </element>
<element> custom_action_element </element>
<element> jsp:text_element </element>
<element> XML_fragments </element>

</union>

</define>
<define>

<id> JavaServerPages:1.2_PFD2:14 </id>
<name>_JavaClasses </name>
<description/>
<union>

<element> element/java_classes/WEB-INF/lib </element>
<element> element/java_classes/WEB-INF/classes </element>
<element> element/java_classes/class-path_META-

INF/MANIFEST </element>

</union>

</define>
<define>

<id> JavaServerPages:1.2_PFD2:15 </id>
<name> IOException </name>
<description> IOException </description>
<union>

<element> java.io.IOException </element>

</union>

</define>
<define>

<Id> JavaServerPages:1.2_PFD2:16 </id>
<name> ClassCastException </name>
<description> ClassCastException </description>
<union>

<element> java.lang.Exception </element>

</union>

</define>
<define>

<id> JavaServerPages:1.2_PFD2:17 </id>
<name> IllegalArgumentException </name>
<description>IllegalArgumentException </description>
<union>

<element> java.lang.IllegallArgumentException </element>

</union>

</define>
<define>

<id> JavaServerPages:1.2_PFD2:18 </id>
<name> ClassCastException </name>
<description> ClassCastException </description>
<union>

<element> java.lang.ClassCastException </element>

</union>

</define>
<define>

<id> JavaServerPages:1.2_PFD2:19 </id>
<name> Instantiate </name>
<description> Instantiate </description>
<union>

<element> java.lang.InstantiateException </element>

</union>

</define>
<define>

<id> JavaServerPages:1.2_PFD2:20 </id>
<name> IllegalStateException </name>
<description> IllegalStateException </description>
<union>

<element> java.lang.IllegalStateException </element>

</union>

</define>
<chapter>

<id> 1 </id>
<name> The Java Server Page Technology </name>
<description>This chapter gives an introduction to the JSP

technology</description>

<section>

<id> 1.1 </id>
<name> Introduction </name>
<description/>
<assertions>

<assertion>

<id> JavaServerPages:1.2_PFD2:1:1.1:1 </id>
<name> /jsp/dynamic_content/HTML </name>
<description>Java Server pages in the technology

to generate dynamic content in HTML</description>

</assertion>
<assertion>

<id> JavaServerPages:1.2_PFD2:1:1.1:2 </id>
<name> /jsp/dynamic_content/DHTML </name>
<description>Java Server pages in the technology

to generate dynamic content in DHTML</description>

</assertion>
<assertion>

<id> JavaServerPages:1.2_PFD2:1:1.1:3 </id>
<name> /jsp/dynamic_content/XHTML </name>
<description>Java Server pages in the technology

to generate dynamic content in XHTML</description>

</assertion>
<assertion>

<id> JavaServerPages:1.2_PFD2:1:1.1:4 </id>
<name> /jsp/dynamic_content/XML </name>
<description>Java Server pages in the technology

to generate dynamic content in XML</description>

</assertion>

</assertions>

</section>
<section>

<id> 1.2.4 </id>
<name> Translation and Execution Steps </name>
<description/>
<assertions>

<assertion>

<id> JavaServerPages:1.2_PFD2:1:1.2.4:1 </id>
<name> /jsp/translation </name>
<description>The jsp pages go through a

translation and execution phase</description>

</assertion>
<assertion>

<id> JavaServerPages:1.2_PFD2:1:1.2.4:2 </id>
<name> /jsp/execution </name>
<description>The jsp pages go through a

translation and execution phase </description>

</assertion>
<assertionimplementation_specific=“true“

type=“deprecated”>

<id> JavaServerPages:1.2_PFD2:1:1.2.4:3 </id>
<name> /jsp/translation/ </name>
<description>deprecated</description>

</assertion>
<assertion>

<id> JavaServerPages:1.2_PFD2:1:1.2.4:4 </id>
<name>

/jsp/container/deployment_time/translation/create_servlet </name>

<description>The jsp pages are translated before

use to provide the web application with a servlet class that represents that page view.
The translation can be done at deployment time</description>

</assertion>
<assertion>

<id> JavaServerPages:1.2_PFD2:1:1.2.4:5 </id>
<name>

/jsp/container/on_demand/translation/create_servlet </name>

<description>The jsp pages are translated before

use to provide the web application with a servlet class that represents that page view.
The translation can be done on demand by the container</description>

</assertion>

</assertions>

</section>

</chapter>
<chapter>

<id> 2 </id>
<name> Core Syntax and Semantics </name>
<description>The chapter outlines the basic syntax and elements used

in a JSP page</description>

<section>

<id> 2.1 </id>
<name> What is a JSP Page </name>
<description>A JSP Page is a textual document that describes

how to create a response object from a request object for a given protocol. The
processing of the JSP Page may involve creating and/or using other objects.
</description>

<assertions>

<assertion>

<id> JavaServerPages:1.2_PFD2:2:2.1:1 </id>
<name> /jsp/protocol/HTTP </name>
<description> HTTP is the default protocol for

requests and responses. </description>

</assertion>
<assertion>

<id> JavaServerPages:1.2_PFD2:2:2.1:2</id>
<name> /jsp/protocol/HTTPs </name>
<description> HTTPs is the secure protocol for

requests and responses that JSP also supports. </description>

</assertion>
<assertion>

<id> JavaServerPages:1.2_PFD2:2:2.1:3 </id>
<name>

/jsp/defaut_request_object/HttpServletRequest </name>

<description>The default request object is

expected to extend HttpServletRequest</description>

</assertion>
<assertion>

<id> JavaServerPages:1.2_PFD2:2:2.1:4 </id>
<name>

/jsp/defaut_response_object/HttpServletResponse </name>

<description>The default request object is

expected to extend HttpServletResponse</description>

</assertion>

</assertions>

</section>
<section>

<id> 2.1.1 </id>
<name> Web Containers and Web Components </name>
<description> A JSP container is a system-level entity that

provides life-cycle management and runtime support for JSP Pages and Servlet
components. Here a web container is synonymous with JSP container </description>

<assertions>

<assertion>

<id> JavaServerPages:1.2_PFD2:2:2.1.1:1 </id>
<name>

/jsp/container/lifecycle_management/same_as_servlets </name>

<description>The lifecycle of JSPs are same as

that of Servlets. </description>

</assertion>
<assertion>

<id> JavaServerPages:1.2_PFD2:2:2.1.1:2 </id>
<name> /jsp/container/runtime_support </name>
<description> The JSP page uses the java

runtime environment upon which the JSP container/web server is running
</description>

</assertion>
<assertion>

<id> JavaServerPages:1.2_PFD2:2:2.1.1:3 </id>
<name>

/jsp/deployment_descriptor/implicit_jsp_extension </name>

<description>The “.jsp“ extension is wired to a

JSP Page.</description>

</assertion>

</assertions>

</section>
<section>

<id> 2.1.2 </id>
<name> XML Document for a JSP Page </name>
<description> All JSP Pages have an equivalent XML

document. This is the view of the JSP Page that is exposed to the translation phase.
</description>

<assertions>

<assertion>

<id> JavaServerPages:1.2_PFD2:2:2.1.2:1 </id>
<name>/jsp/translation/XML_document

</name>

<description>A JSP Page can also be written

directly as its equivalent XML document. This is delivered directly to a JSP container
for processing </description>

</assertion>
<assertion>

<id> JavaServerPages:1.2_PFD2:2:2.1.2:2 </id>
<name> /jsp/format/XML </name>
<description> The JSP XML format should be

unique. It is not valid to intermix “standard syntax” and XML syntax inside the same
source file </description>

</assertion>
<assertion type=“negative”>

<id> JavaServerPages:1.2_PFD2:2:2.1.2:3 </id>
<name> /jsp/page/format/HTML_and_XML

</name>

<description>HTML and XML can intermixed in

the source </description>

</assertion>

</assertions>

</section>

.
.
.

</chapter>

</spec>

FIG. 3 is a flow chart diagram 300 of method operations performed to create an XML assertion document, in accordance with one embodiment of the present invention. The method begins in operation 302 in which a software specification document to be implemented for testing is provided followed by operation 304 wherein an XML file is generated. In operation 306, the specification portion of the specification document is tagged in the XML file. In one embodiment, tagging the specification portion includes implementing the specification document name, specification document id, specification document version, and a description of the specification document.

Proceeding to operation 308, the assertion writer goes through the specification document so as to find an assertion. By way of example, in one embodiment, the assertion can be easily identified, while in a different embodiment, the text in the specification document is analyzed to find the assertion. Thereafter, in operation 310, the assertion is tagged in the XML file. In one example, tagging the assertion includes the assertion id, the assertion name, and the assertion description. Additional details regarding tagging the assertion has been provided above with respect to FIGS. 1A through 2A-5.

Continuing to operation 312, it is determined whether the specification document contains additional assertions to be tagged. If there are any additional assertions to be tagged, the method continues to operation 310 in which the additional assertions are tagged. If there are no additional assertions to be tagged, the method continues to operation 314 in which the Extensible Stylesheet Language (“XSLT”) is used to transform the XML file to an HTML file, thus displaying information requested by a user. In a different embodiment, XSLT Stylesheet may be used to transform the XML file into any requested format (e.g., HTML, PDF, etc.) In this manner, beneficially, substantially all information provided in the specification document can be tagged using XML. Any of the tagged information can be implemented as an index for information retrieval and display. Additionally, depending on a user's need, the tagged information can be automatically retrieved and displayed, substantially reducing the time consuming task of finding and mapping the assertions, as performed by the prior art.

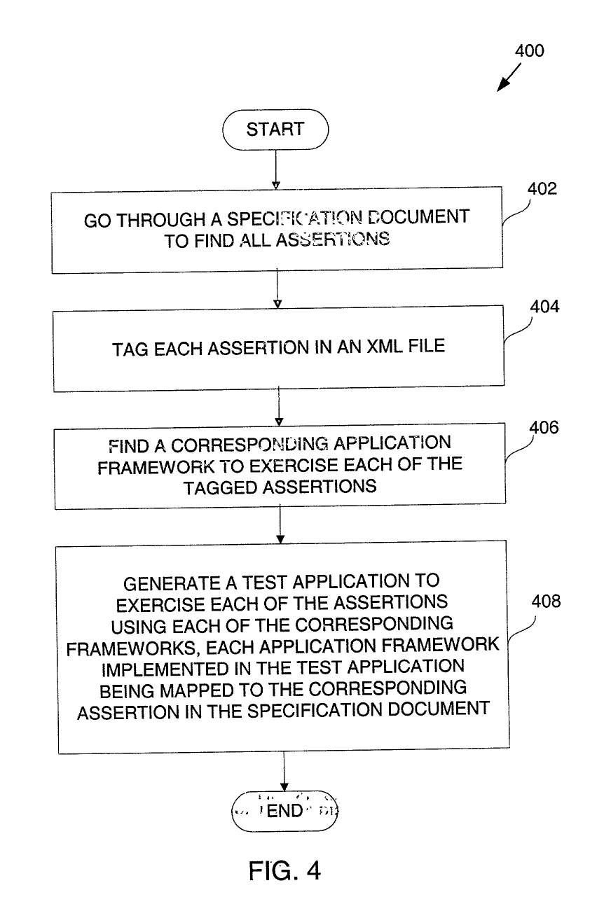

FIG. 4 is a flow chart diagram 400 of method operations performed to create an assertion document using a software specification document, in accordance with one embodiment of the present invention. The method begins in operation 402 in which a software specification document is reviewed to find almost all assertions. In one example, an assertion writer is configured to perform this task.

Proceeding to operation 404, each assertion in the specification document is tagged in an XML file. Then, in operation 406, a corresponding application framework is found to exercise each of the tagged assertions. In operation 408, a test application is generated to exercise the assertions using each of the corresponding frameworks. Each of the application frameworks implemented in the test application is mapped to the respective assertion in the specification document. Advantageously, the time consuming task of mapping the application frameworks to each of the assertions can be performed easily, thus substantially reducing time spent by each of the test developers.

The advantages of the present invention are numerous. Most notably, in the embodiments of the present invention, a defined DTD can be implemented to represent substantially all possible scenarios, assertions, or requirements specification document in a given technology. In this manner, the information in a specification document can be indexed allowing retrieval of information, as needed. Another advantage of embodiments of the present invention is its capability to display the specification documents in different formats, for different purposes and as needed. Yet another advantage of the present invention is that it allows the information and document arrived at during the test development process to be shared between different groups, each having a different focus. Still another advantage of the present invention is that it allows automatic execution of software test processes for a particular feature. Still another advantage is that the present invention increases the level of the parties' (e.g., managers, developers, testers, etc.) confidence on the specification, as the embodiments of the present invention can implement the indexed information to measure the specification coverage. Yet another advantage of the embodiments of the present invention is that using the keywords enables the selection and execution of a specific test having a particular feature (e.g., security, etc.)

With the above embodiments in mind, it should be understood that although the present invention mainly describes exemplary embodiments of implementing XML representation of software specification documents, it must be understood by one having ordinary skill in the art that the XML representation of the present invention can be implemented to represent any document (e.g., specifications, implementation requirements, implementation design, etc.). Furthermore, although in the present invention the XML has been implemented for representing the assertions in the specification document, in a different embodiment, any suitable language capable of tagging the software documents can be implemented. Furthermore, although the embodiments of the present invention implement XSLT Stylesheet to display the assertion document, in a different embodiment, any suitable language to display the assertion document in any format desired.

Additionally, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter, be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Furthermore, although the present invention implements Java programming language, other programming languages may be used to implement the embodiments of the present invention (e.g., C, C++, any object oriented programming language, etc.).

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for tracking assertions in an application, comprising:
providing a specification for the application, the specification being divided into chapters defining functional aspects of the application;
identifying each assertion in each chapter of the specification; and
generating a markup language document, the markup language document having an associated tagged entry for each of the identified assertions, each tagged entry having an identifier tag, the identifier tag correlating the tagged entry to a specific chapter of the specification.

2. A method for tracking assertions in an application as recited in claim 1, wherein the markup language document has an associated specification tagged entry for the specification, the specification tagged entry having a specification identifier tag.

3. A method for tracking assertions in an application as recited in claim 1, wherein the markup language document has an associated chapter tagged entry for each of the chapters, each chapter tagged entry having a chapter identifier tag.

4. A method for tracking assertions in an application as recited in claim 1, wherein the identifier tag for each assertion is unique.

5. A method for tracking assertions in an application as recited in claim 1, wherein the tagged entry for each identified assertion has an associated keyword, the keyword configured to facilitate extracting of the assertion.

6. A method for tracking assertions in an application as recited in claim 1, wherein the tagged entry for the identified assertion includes a depends tag describing the dependency of the identified assertion on a previously tagged identified assertion.

7. A method for tracking assertions in an application as recited in claim 1, wherein the tagged entry for the identified assertion includes a sub-assertions tag.

8. A method for tracking assertions in an application as recited in claim 1, wherein the markup language is an extensible markup language (XML).

9. A method for tracking assertions in an application, comprising:
providing a specification for the application, the specification being divided into chapters defining functional aspects of the application;
identifying each assertion in each chapter of the specification; and
generating markup language document, the markup language document having an associated tagged entry for each of the identified assertions, each tagged entry having an identifier tag, the identifier tag correlating the tagged entry to a specific chapter of the specification; and
displaying the markup language document,
wherein the associated tagged entry for each of the identified assertions facilitates retrieval of a requested assertion.

10. A method for tracking assertions in an application as recited in claim 9, wherein the identifier tag for each assertion includes a specification identifier, a specification version, a chapter number, and an assertion identification.

11. A method for tracking assertions in an application as recited in claim 9, wherein the identifier tag for each assertion includes a specification identifier tag, a specification version, a chapter number, a section number, and an assertion identification.

12. A method for tracking assertions in an application as recited in claim 9, wherein the tagged entry for each identified assertion has an associated keyword tag, the keyword tag configured to facilitate extracting of the specific assertion.

13. A method for tracking assertions in an application as recited in claim 9, wherein the tagged entry for the identified assertion includes a depends tag describing the dependency of the identified assertion on a previously tagged identified assertion.

14. A method for tracking assertions in an application as recited in claim 9, wherein the markup language document has an associated chapter tagged entry for each of the chapters, each chapter tagged entry having a chapter identifier tag.

15. A method for tracking assertions in an application as recited in claim 9, wherein the identifier tag for each assertion is unique.

16. A method for tracking assertions in an application as recited in claim 9, wherein the markup language is an extensible markup language (XML).

17. A method for tracking assertions in an application as recited in claim 16, wherein Extensible Stylesheet Language (XSLT) Stylesheet is implemented to transform the markup document to be displayed in a selected format.

18. A computer program embodied on a computer readable medium for facilitating a retrieval of an assertion in an application, the computer program comprising:
a code segment that receives a request to locate a particular assertion;
a code segment that runs during an execution of the computer program, the code segment configured to inspect a markup language document to find the particular assertion; and
a code segment that provides a response to the request to locate the particular assertion.

19. A computer program embodied on a computer readable medium for facilitating a retrieval of an assertion in an application as recited in claim 18, wherein the markup language document is generated from a specification of the application, the markup language document having an associated tagged entry for each assertion identified in the specification, each tagged entry having an identifier tag correlating the tagged entry to a specific chapter of the specification.

20. A computer program embodied on a computer readable medium for facilitating a retrieval of an assertion in an application as recited in claim 18, wherein the code segment that runs during the execution of the computer program locates the specific assertion using one of an assertion identifier tag, assertion name tag, and an assertion description tag.
